(19) United States
(12) Patent Application Publication
(10) Pub. No.: US 2015/0186815 A1
(43) Pub. Date: Jul. 2, 2015

(54) SYSTEM AND METHOD FOR ANALYSING BUSINESS ENVIRONMENT OF OVERSEAS GAS PLANT PROJECT

(71) Applicant: Industry-Academic Cooperation Foundation, Yonsei University, Seoul (KR)

(72) Inventors: Seung Heon Han, Gwacheon-si (KR); Woo Sik Jang, Seoul (KR); Heedae Park, Seoul (KR); Seokjin Choi, Seoul (KR)

(73) Assignee: Industry-Academic Cooperation Foundation, Yonsei University, Seoul (KR)

(21) Appl. No.: 14/205,538

(22) Filed: Mar. 12, 2014

(30) Foreign Application Priority Data
Dec. 30, 2013 (KR) 10-2013-0167113

(51) Int. Cl. G06Q 10/06; G06Q 50/06

(52) U.S. Cl. CPC G06Q 10/0635; G06Q 50/06

(57) ABSTRACT

A system for analyzing country's business environment of an overseas gas field development project includes a political system stability assessment section configured to calculate a political system stability index; a business execution stability assessment section configured to respectively calculate a general business execution stability index, an upstream expected reward index, a downstream expected reward index, and a business promotion condition index; and an overall business environment assessment section configured to calculate a business environment index, based on the political system stability index, the business execution stability index, the upstream expected reward index, the downstream expected reward index and the business promotion condition index.

### CROSS-REFERENCES TO RELATED APPLICATIONS

The present application claims priority under 35 U.S.C 119(a) to Korean Patent Application No. 10-2013-0167113, filed on Dec. 30, 2013 in the Korean Intellectual Property Office, which is incorporated herein by reference in its entirety set forth in full.

### TECHNICAL FIELD

Exemplary embodiments of the present invention relate to country's business potentiality assessment of a development project, and more particularly, to a technique for analyzing country's business environment of an overseas gas field development project.

### BACKGROUND OF THE INVENTION

Recently, the demand for natural gas has increased since the emission of a carbon dioxide has half the amount compared to coal and the emissions of a nitrogen oxide and a sulfur oxide are also smaller when compared with natural gas used as a fuel for power generation or a fuel for heating. While the reserve production ratio (R/P) of natural gas was expected in the past to be about 70 years, the reserve production ratio is abruptly increasing nowadays due to recent development boom of shale gas. Therefore, it is highly likely that the utilization of natural gas will be increased in the future when compared to petroleum which has the reserve production ratio of about 40 years.

Global natural gas markets are generally divided into North America, Europe and East Asia. Among these markets, even though East Asia has emerged as the largest natural gas consuming region, the price of natural gas (LNG) from Indonesia that is regarded as the standard market price is about 2 to 4 times higher than HH (Henry Hub) and the US market standard or NPB (National Balancing Point) and the European market standard. In North America or Europe, because gas is stably supplied in large quantities through gas pipelines, the price of gas is cheap. However, in East Asia or Africa, because gas is supplied through shipping, the price of gas is expensive although shipping has become flexible to a certain extend.

Specifically, Korea's average import price of LNG is 14.72 dollars per MBTU (1000 British Thermal Units), which is higher compared to the world's average of 8.95 dollars and the US average of 1.5 dollars. This may result due to focusing on only stable import of LNG and neglecting the development of overseas gas fields.

Enterprises that participate in overseas gas field development projects process them through a business selection stage, a business feasibility studying stage, Pre-FEED (preliminary front end engineering design) and FEED (front end engineering design) stage, an engineering-procurement-construction (EPC) stage, and an operating stage.

The business selection stage and the feasibility studying stage are considered before determining the business which is to assess the business potential and thereby searching for good business opportunity at an initial stage, where the details of business and whether to participate in the business is not decided.

In the business selection stage and the feasibility studying stage, risk should be assessed at the extreme initial stage of the business, based on very limited information. It is necessary to assess business stability and an appropriate level of risk that may be endured by the enterprise.

Traditional researches for analyzing the business environment of overseas markets are generally related with the deduction and assessment of risk factors, where the approaches were made from the viewpoint of the contractor.

For example, researches have aimed for methodologies of dividing business environment of host countries in terms of politics, economy, institutional system, integrating the host countries and owner perspectives, and ensuring easiness in logistics such as of materials and equipment.

Consequently, as the studies have been generally focused on the viewpoints of engineers and contractors, the reflection of important elements from the viewpoints of investors and developers were insufficient.

### SUMMARY

Embodiments of the present invention are directed to system and method for analyzing country's business environment of an overseas gas field development project.

Embodiments of the present invention are directed to system and method for analyzing country's business environment of an overseas gas field development project in terms of investment and reward as well as in terms of project development, EPC (engineering, procurement, construction) and Operation perspectives.

Embodiments of the present invention are directed to system and method for analyzing country's business environment of an overseas gas field development project in consideration of all processes including drilling of a gas field, construction of a plant, mining, refinement, treatment, transportation, storage, and sale.

Problems to be solved by the present invention are not limited to the above-mentioned ones, and other problems which are not mentioned above may be clearly understood from the following descriptions are for the concerned personnel.

In accordance with an aspect of the present invention, a system for analyzing country's business environment of an overseas gas field development project may include: a political system stability assessment section configured to calculate a political system stability index for macroscopic stability of political and social systems of a host country that owns an overseas gas field as a development target; a business execution stability assessment section configured to respectively calculate a general business execution stability index for smoothness of investment and business and stability of executing business in the host country, an upstream expected reward index for an expected reward in an upstream field for investment of the overseas gas field development project, a downstream expected reward index for an expected reward in a downstream field for investment of the overseas gas field development project, and a business promotion condition index for administrative conditions and competitive conditions of the gas industry of an host country; and an overall business environment assessment section configured to calculate a business environment index, based on the political system stability index, the business execution stability index, the upstream expected reward index, the downstream expected reward index and the business promotion condition index.

In an embodiment, the political system stability index may be calculated, based on assessment values respectively quantified for assessment items including voice and accountability, political stability and absence of violence, government effectiveness, regulatory quality, rule of law, and control of corruption.

In an embodiment, the political system stability index may be calculated, based on any one selected from summation, weighted summation, arithmetic averaging, and weighted averaging of the assessment values that are quantified for the respective assessment items.

In an embodiment, the assessment values for the assessment items of the political system stability index may be quantified by referring to the Worldwide Governance Indicator (WGI) that is annually published by the World Bank.

In an embodiment, the general business execution stability index may be calculated, based on assessment values respectively quantified for assessment items including starting a business, dealing with construction permits, getting electricity, registering property, getting credit, protecting investors, paying taxes, trade across borders, enforcing contracts, and resolving insolvency.

In an embodiment, the general business execution stability index may be calculated, based on any one selected from summation, weighted summation, arithmetic averaging and weighted averaging of the assessment values that are quantified for the respective assessment items.

In an embodiment, the assessment values for the assessment items of the general business execution stability index may be quantified by referring to the Doing Business Indicator (DBI) that is annually published commonly by the World Bank and the International Finance Corporation (IFC), and Distance to Frontier (DF) values provided therewith, for the assessment items.

In an embodiment, the upstream expected reward index may be calculated, based on assessment values respectively quantified for assessment items including natural gas reserves, average annual production of natural gas, maximum production of natural gas, growth rate of production of natural gas, ratio of upstream properties not owned by a government, and ratio of upstream enterprises not owned by the government.

In an embodiment, the upstream expected reward index may be calculated, based on any one selected from summation, weighted summation, arithmetic averaging and weighted averaging of the assessment values that are quantified for the respective assessment items.

In an embodiment, the downstream expected reward index may be calculated, based on assessment values respectively quantified for assessment items including annual local demand for natural gas, growth rate of local demand for natural gas, local supply-demand ratio of natural gas, ratio of downstream properties not owned by the government, and ratio of downstream enterprises not owned by the government.

In an embodiment, the downstream expected reward index may be calculated, based on any one selected from summation, weighted summation, arithmetic averaging and weighted averaging of the assessment values that are respectively quantified for the respective assessment items.

In an embodiment, the business promotion condition index may be calculated, based on assessment values respectively quantified for assessment items including energy-related policies of the government of the host country, a natural gas management structure of the government of the host country, a current situation of similar projects in progress on the site, and a current situation of similar projects under planning on the site.

In an embodiment, the business promotion condition index may be calculated, based on any one selected from summation, weighted summation, arithmetic averaging and weighted averaging of the assessment values that are quantified for the respective assessment items.

In an embodiment, the business environment index may be calculated, based on any one selected from summation, weighted summation, arithmetic averaging and weighted averaging of the political system stability index, the business execution stability index, the upstream expected reward index, the downstream expected reward index and the business promotion condition index.

In accordance with another aspect of the present invention, a method for analyzing country's business environment of an overseas gas field development project, using a system for analyzing country's business environment of an overseas gas field development project, which includes a political system stability assessment section, a business execution stability assessment section and an overall business environment assessment section, may include: calculating, by the political system stability assessment section, a political system stability index for macroscopic stability of political and social systems of a country that owns an overseas gas field as a development target, that is, a host country; calculating, by the business execution stability assessment section, a general business execution stability index for smoothness of investment and business and stability of executing business in the host country; calculating, by the business execution stability assessment section, an upstream expected reward index for an expected reward in an upstream field for investment of the overseas gas field development project; calculating, by the business execution stability assessment section, a downstream expected reward index for an expected reward in a downstream field for investment of the overseas gas field development project; calculating, by the business execution stability assessment section, a business promotion condition index for administrative conditions and competitive conditions of the gas industry of an host country; and calculating, by the overall business environment assessment section, a business environment index, based on the political system stability index, the business execution stability index, the upstream expected reward index, the downstream expected reward index and the business promotion condition index.

In an embodiment, the political system stability index may be calculated, based on assessment values respectively quantified for assessment items including voice and accountability, political stability and absence of violence, government effectiveness, regulatory quality, rule of law, and control of corruption.

In an embodiment, the assessment values for the assessment items of the political system stability index may be quantified by referring to the Worldwide Governance Indicator (WGI) that is annually published by the World Bank.

In an embodiment, the general business execution stability index may be calculated, based on assessment values respectively quantified for assessment items including starting a business, dealing with construction permits, getting electricity, registering property, getting credit, protecting investors, paying taxes, trade across borders, enforcing contracts, and resolving insolvency.

In an embodiment, the assessment values for the assessment items of the general business execution stability index may be quantified by referring to the Doing Business Indicator (DBI) that is annually published commonly by the World Bank and the International Finance Corporation (IFC), and Distance to Frontier (DF) values provided therewith, for the assessment items.

In an embodiment, the upstream expected reward index may be calculated, based on assessment values respectively quantified for assessment items including natural gas reserves, average annual production of natural gas, maximum production of natural gas, growth rate of production of natural gas, ratio of upstream properties not owned by a government, and ratio of upstream enterprises not owned by the government.

In an embodiment, the downstream expected reward index may be calculated, based on assessment values respectively quantified for assessment items including annual local demand for natural gas, growth rate of local demand for natural gas, local supply-demand ratio of natural gas, ratio of downstream properties not owned by the government, and ratio of downstream enterprises not owned by the government.

In an embodiment, the business promotion condition index may be calculated, based on assessment values respectively quantified for assessment items including energy-related policies of the government of the host country, a natural gas management structure of the government of the host country, a current situation of similar projects in progress on the site, and a current situation of similar projects under planning on the site.

In an embodiment, the business environment index may be calculated, based on any one selected from summation, weighted summation, arithmetic averaging and weighted averaging of the political system stability index, the business execution stability index, the upstream expected reward index, the downstream expected reward index and the business promotion condition index.

According to the system and the method for analyzing business environment of an overseas gas field development project in accordance with the embodiment of the present invention, it is possible to analyze business environment of an overseas gas field development project in terms of investment and reward as well as in terms of construction or EPC perspectives.

According to the system and the method for analyzing country's business environment of an overseas gas field development project in accordance with the embodiment of the present invention, it is possible to analyze business environment of an overseas gas field development project in consideration of not only the macroscopic situation of an host country but also all processes including drilling of a gas field, construction of a plant, mining, refinement, treatment, transportation, storage, and sale.

According to the system and the method for analyzing country's business environment of an overseas gas field development project in accordance with the embodiment of the present invention, it is possible to analyze business environment of an overseas gas field development project based on objective and reliable indexes and data rather than on the intuitive and subjective judgment of an expert or a staff.

Effects of the present invention are not limited to the above-mentioned ones, and other effects which are not mentioned above may be clearly understood from the following descriptions for the concerned personnel.

### BRIEF DESCRIPTION OF THE DRAWINGS

The above aspects, features and other advantages will be more clearly understood from the following detailed description taken in conjunction with the accompanying drawings, in which:

FIG. 1 is a conceptual diagram illustrating a system for analyzing business environment of an overseas gas field development project in accordance with an embodiment of the present invention;

FIG. 2 is a conceptual diagram showing assessment indexes, quantification standards and weights of business environment analysis in the system for analyzing business environment of an overseas gas field development project in accordance with the embodiment of the present invention; and

FIG. 3 is a flow chart exemplarily explaining a method for analyzing business environment of an overseas gas field development project in accordance with an embodiment of the present invention.

### DESCRIPTION OF SPECIFIC EMBODIMENTS

In the embodiments of the present invention disclosed herein, specific structural and functional descriptions are given for an illustration purpose only to describe the embodiments of the present invention. The embodiments of the present invention may be implemented in various forms and should not be construed as limited to those set forth herein.

Hereinafter, exemplary embodiments of the present invention will be described in more detail with reference to the accompanying drawings. Hereinafter, the same reference numerals will be used to describe the same components throughout the accompanying drawings, and repeated descriptions for the same components will be omitted.

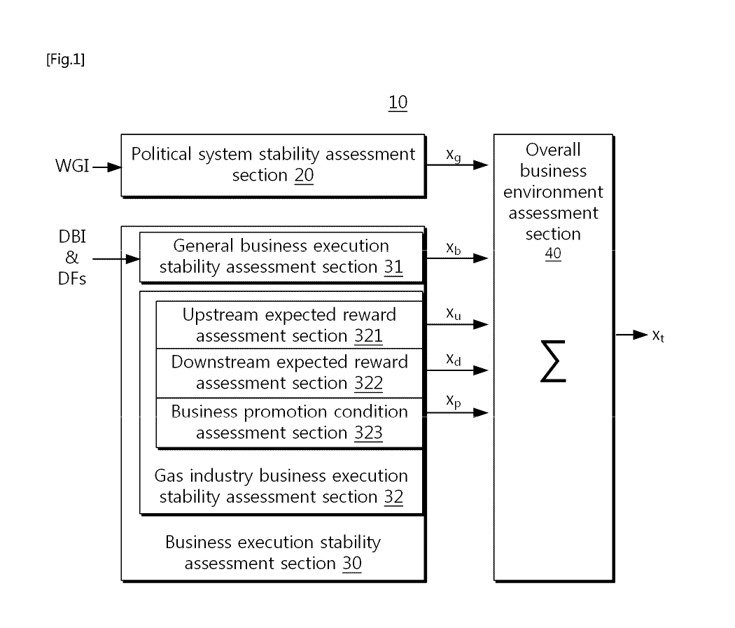

FIG. 1 is a conceptual diagram illustrating a system for analyzing business environment of an overseas gas field development project in accordance with an embodiment of the present invention.

The first stage for determining whether to participate in an overseas gas field development project is a business environment analyzing stage.

Prior to reviewing the details of the overseas gas field development project which is under consideration in terms of whether to participate, appropriateness of participation and investment may be determined by analyzing the characteristic and the business conditions of a host country from a macroscopic viewpoint, through the business environment analyzing stage.

The traditional business environment analyzing methodologies mainly focus on the viewpoint of a contractor of construction business and thus insufficiently reflect viewpoints in terms of investment and development, and also mainly focus on the determination of risk factors which are likely to degrade business profitability and thus are insufficient in terms of business opportunity and expected reward. Moreover, the traditional business environment analyzing methodologies rely more on the subjective judgment of an expert or a staff rather than on objective and reliable indexes, and the detailed assessment techniques thereof utilize a checklist or a probability-impact assessment, thereby focusing on the assessment of a relative level and lacking judgment of an absolute level.

The present invention created to overcome these problems relates to a business environment analyzing methodology which is designed to more utilize objective data while reviewing the aspects of institutional conditions of an host country such as politics and economy, social stability, stability in executing business by a foreign enterprise in the market of the corresponding country, and success opportunity of energy and natural resource industries.

Since the overseas gas field development project is a long-term project which requires several decades once it is started, it is essential to review the maturity of the political and social systems of the host country, stability in laws and regulations, government effectiveness and corruption, etc. from macroscopic viewpoints, that is, the stability of political systems.

Further, in order to assess smoothness of investment and business and stability of executing business in the host country, that is, in order to assess the general and broad stability of executing business, it is necessary to consider characteristics such as the natures of administrative procedures, protection of property and investment of foreign investors, tax and contract compliance, and justice in dispute procedures.

Finally, in order to assess stability of executing business specialized to the gas industry to which the overseas gas field development project belongs, it is necessary to check the business promotion conditions of the overseas gas field development project, by figuring out the levels of expected rewards in the upstream and downstream of the gas industry, the number of similar projects are currently progressed on the site, the gas industry policy of the government, and the investment prospect.

Referring to FIG. 1, a system 10 for analyzing business environment of an overseas gas field development project to realize a new business environment analyzing methodology in the respect described above may include a political system stability assessment section 20, a business execution stability assessment section 30, and an overall business environment assessment section 40.

The business execution stability assessment section 30 may include a general business execution stability assessment section 31 and a gas industry business execution stability assessment section 32.

The gas industry business execution stability assessment section 32 may include an upstream expected reward assessment section 321, a downstream expected reward assessment section 322, and a business promotion condition assessment section 323.

The political system stability assessment section 20 calculates a political system stability index x_{g} for the macroscopic stability of the political and social systems of a country that owns an overseas gas field as a development target, that is, a host country.

In detail, the political system stability assessment section 20 calculates the political system stability index x_{g}, based on assessment values respectively quantified for assessment items including voice and accountability, political stability and absence of violence, government effectiveness, regulatory quality, rule of law, and control of corruption.

According to an embodiment, the political system stability index x_{g} may be calculated, based on any one selected from summation, weighted summation, arithmetic averaging and weighted averaging of the assessment values respectively quantified for the respective assessment items.

In order for objective index calculation, the political system stability assessment section 20 may quantify assessment values for the assessment items of the political system stability index x_{g}, by referring to the Worldwide Governance Indicator (WGI) that is annually published by the World Bank.

The Worldwide Governance Indicator (WGI) is information in which scores between −2.5 (poor) and +2.5 (excellent) are afforded to respective countries in terms of the assessment items including voice and accountability, political stability and absence of violence, government effectiveness, regulatory quality, rule of law, and control of corruption, and may be acquired in a spreadsheet file from the home page of the World Bank.

In this case, the political system stability assessment section 20 may calculate the political system stability index x_{g} by converting each assessment value x_{gi} (i is an integer satisfying 1≦i≦6) for each of the six assessment items of the Worldwide Governance Indicator (WGI), from the section of [−2.5, +2.5] into the section of [0, 100], and then performing arithmetic averaging.

As described above, the business execution stability assessment section 30 may include the general business execution stability assessment section 31 and the gas industry business execution stability assessment section 32.

The general business execution stability assessment section 31 calculates the general business execution stability index x_{b} for smoothness of investment and business and stability of executing business in the host country.

In detail, the general business execution stability assessment section 31 calculates the general business execution stability index x_{b}, based on assessment values respectively quantified for assessment items including starting a business, dealing with construction permits, getting electricity, registering property, getting credit, protecting investors, paying taxes, trade across borders, enforcing contracts, and resolving insolvency.

According to an embodiment, the general business execution stability index x_{b} may be calculated, based on any one selected from summation, weighted summation, arithmetic averaging and weighted averaging of the assessment values respectively quantified for the respective assessment items.

In order for objective index calculation, the general business execution stability assessment section 31 may refer to the Doing Business Indicator (DBI) that is annually published commonly by the World Bank and the International Finance Corporation (IFC) with respect to business performance easiness of 185 countries over the world, and Distance to Frontier (DF) values provided therewith.

The Doing Business Indicator (DBI) is useful in assessing relative levels between current business environment of a country and the other countries based on assessment for laws and regulations associated with business activities in respective countries. The Doing Business Indicator (DBI) provides individual assessments and ranks and overall ranks for the total 10 items including starting a business, dealing with construction permits, getting electricity, registering property, getting credit, protecting investors, paying taxes, trade across borders, enforcing contracts, and resolving insolvency. Since the assessment standards of the respective items are different from one another, it is difficult to judge the absolute levels of the assessment values or the ranks thereof although relative comparison of the assessment values or the ranks thereof between countries is possible. In order to cope with this problem, the World Bank also provides the Distance to Frontier (DF) values which represent score differences between a best performance country and the other countries by the values of 0 to 100.

Accordingly, the general business execution stability assessment section 31 may calculate the general business execution stability index x_{b} by arithmetically averaging the Distance to Frontier (DF) values of the respective assessment items which are published along with the 10 assessment items of the Doing Business Indicator (DBI), without separate conversion.

Meanwhile, the ecosystem of the gas industry for supplying gas from a gas field to demand sources is divided into an upstream field which is associated with development, drilling and operation of a gas field, a mid-stream field which is associated with transportation and treatment facilities, and a downstream field which is associated with refinement and sale. The downstream field may often include the mid-stream field.

When any one of the business fields in the gas industry ecosystem is insufficient, the business potentialities of the other fields may be adversely affected. Therefore, in the business environment of the overseas gas field development project, the downstream field as well as the upstream field for the development of a gas field should be considered.

Hence, the gas industry business execution stability assessment section 32 includes the upstream expected reward assessment section 321, the downstream expected reward assessment section 322 and the business promotion condition assessment section 323, and may calculate an upstream expected reward index xᵤ, a downstream expected reward index x_{d} and a business promotion condition index xₚ, respectively, for the stability of the execution of business specialized to the gas industry.

The upstream expected reward assessment section 321 calculates the upstream expected reward index xᵤ for an expected reward in the upstream field for the investment of the overseas gas field development project.

In general, since the energy industry tends to be controlled by the government of the host country, the rates or presence of properties and enterprises not owned by the government is importantly judged when assessing the upstream expected reward.

Therefore, in detail, the upstream expected reward assessment section 321 calculates the upstream expected reward index xᵤ, based on assessment values respectively quantified for assessment items including natural gas reserves, average annual production of natural gas, maximum production of natural gas, growth rate of production of natural gas, ratio of upstream properties not owned by the government, and ratio of upstream enterprises not owned by the government.

According to an embodiment, the upstream expected reward index xᵤ may be calculated, based on any one selected from summation, weighted summation, arithmetic averaging and weighted averaging of the assessment values respectively quantified for the respective assessment items.

For example, the weight of 0.1875 may be applied to each of the first four assessment items associated with natural gas production activities, that is, natural gas reserves, average annual production of natural gas, maximum production of natural gas and growth rate of production of natural gas, such that the first four assessment items occupy 75% of the upstream expected reward index xᵤ, and the weight of 0.125 may be applied to each of the remaining two assessment items.

The downstream expected reward assessment section 322 calculates the downstream expected reward index x_{d} for an expected reward in the downstream field for the investment of the overseas gas field development project.

Similarly to the case of the upstream expected reward, the rates or presence of properties and enterprises not owned by the government is importantly judged when assessing the downstream expected reward.

Therefore, in detail, the downstream expected reward assessment section 322 calculates the downstream expected reward index x_{d}, based on assessment values respectively quantified for assessment items including annual local demand for natural gas, growth rate of local demand for natural gas, local supply-demand ratio of natural gas, ratio of downstream properties not owned by the government, and ratio of downstream enterprises not owned by the government.

According to an embodiment, the downstream expected reward index x_{d} may be calculated, based on any one selected from summation, weighted summation, arithmetic averaging and weighted averaging of the assessment values respectively quantified for the respective assessment items.

For example, the weight of 0.25 may be applied to each of the first three assessment items associated with natural gas consumption activities, that is, annual local demand for natural gas, growth rate of local demand for natural gas and local supply-demand ratio of natural gas, such that the first three assessment items occupy 75% of the downstream expected reward index x_{d}, and the weight of 0.125 may be applied to each of the remaining two assessment items.

The business promotion condition assessment section 323 calculates the business promotion condition index xₚ for energy-related policies (investment and promotion policies) of the government of the host country, an administrative agency structure, and a current situation of similar projects in progress or under planning on the site, that is, the administrative conditions and competitive conditions of the gas industry of the host country, so as to ensure the continuation of gas business and the growth of the gas industry.

In detail, the business promotion condition assessment section 323 calculates the business promotion condition index xₚ, based on assessment values respectively quantified for assessment items including energy-related policies of the government of the host country, a natural gas management structure of the government of the host country, a current situation of similar projects in progress on the site, and a current situation of similar projects under planning on the site. The assessment items such as energy-related policies of the government of the host country and a natural gas management structure of the government of the host country may be quantified, based on the qualitative assessment of an expert.

According to an embodiment, the business promotion condition index xₚ may be calculated, based on any one selected from summation, weighted summation, arithmetic averaging and weighted averaging of the assessment values respectively quantified for the respective assessment items.

For example, the weight of 0.3 may be applied to each of the government-related assessment items such as energy-related policies of the government of the host country and a natural gas management structure of the government of the host country, such that the government-related assessment items occupy 60% of the business promotion condition index xₚ, and the weight of 0.2 may be applied to each of the remaining two assessment items for the situations of similar projects.

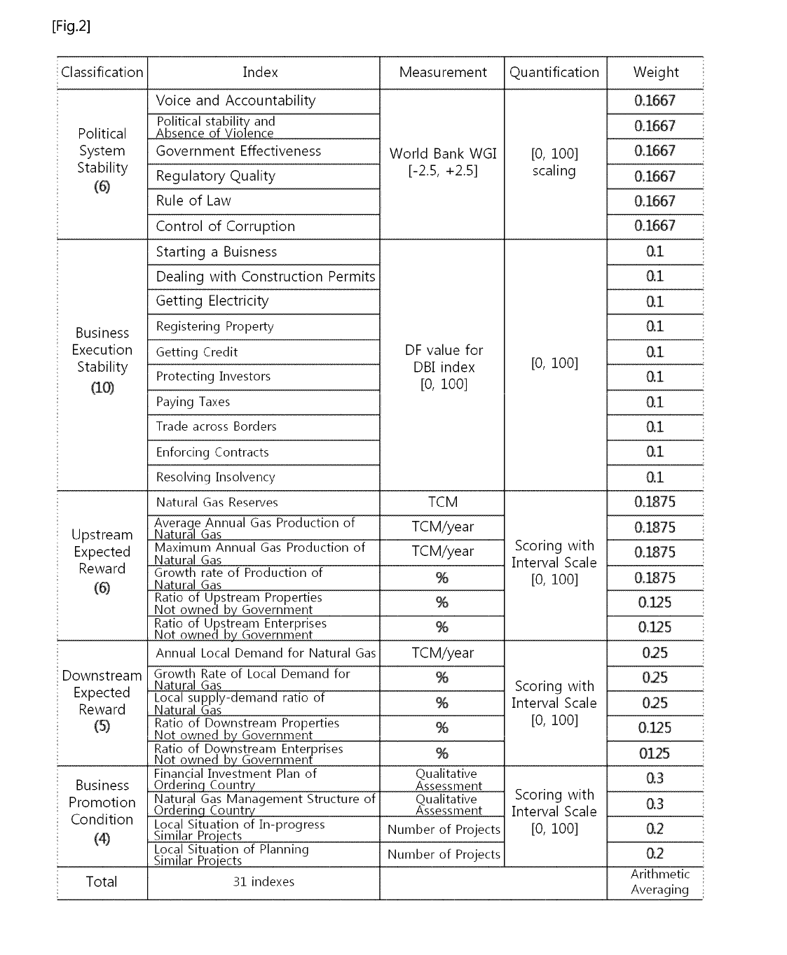

The various assessment indexes discussed above are exemplarily shown in FIG. 2.

FIG. 2 is a conceptual diagram showing assessment indexes, quantification standards and weights of business environment analysis in the system for analyzing business environment of an overseas gas field development project in accordance with the embodiment of the present invention.

In FIG. 2, the assessment indexes used for analyzing business environment are largely divided into 5 parts, and the respective parts have pluralities of detailed assessment indexes. The detailed assessment indexes are calculated, based on the data that are published from reputable organizations, to ensure objectivity.

Since the detailed assessment indexes should be summed, they may be converted to have the same scale.

The detailed assessment indexes of each part may be arithmetically averaged or weight-averaged and be calculated as the index of the corresponding part.

Further, the indexes of the respective parts may be arithmetically averaged or weight-averaged and be calculated as a final business environment index.

Referring back to FIG. 1, the overall business environment assessment section 40 receives the political system stability index x_{g} from the political system stability assessment section 20 and receives the business execution stability index x_{b}, the upstream expected reward index xᵤ, the downstream expected reward index x_{d} and the business promotion condition index xₚ from the business execution stability assessment section 30, and calculates a business environment index xₜ based on the political system stability index x_{g}, the business execution stability index x_{b}, the upstream expected reward index xᵤ, the downstream expected reward index x_{d} and the business promotion condition index xₚ which are received.

According to an embodiment, the business environment index xₜ may be calculated, based on any one selected from summation, weighted summation, arithmetic averaging and weighted averaging of the respective indexes x_{g}, x_{b}, xᵤ, x_{d} and xₚ.

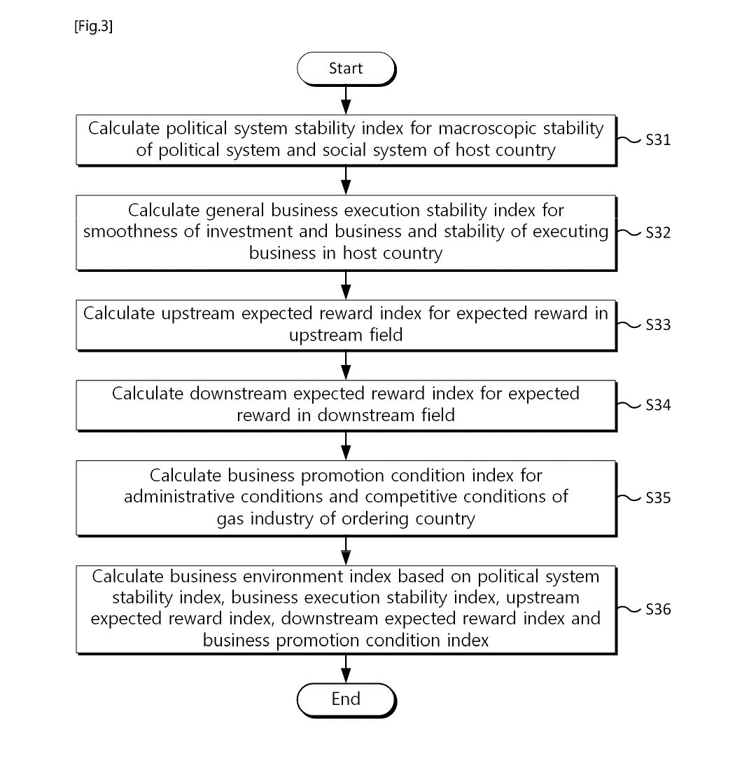

FIG. 3 is a flow chart exemplarily explaining a method for analyzing business environment of an overseas gas field development project in accordance with an embodiment of the present invention.

The method for analyzing business environment of an overseas gas field development project, which uses the system 10 for analyzing business environment of an overseas gas field development project, including the political system stability assessment section 20, the business execution stability assessment section 30 and the overall business environment assessment section 40, starts from stage S31, in which the political system stability assessment section 20 calculates the political system stability index x_{g} for the macroscopic stability of the political and social systems of a country that owns an overseas gas field as a development target, that is, a host country.

In detail, the political system stability index x_{g} is calculated, based on assessment values respectively quantified for assessment items including voice and accountability, political stability and absence of violence, government effectiveness, regulatory quality, rule of law, and control of corruption.

According to an embodiment, the political system stability index x_{g} may be calculated, based on any one selected from summation, weighted summation, arithmetic averaging and weighted averaging of the assessment values respectively quantified for the respective assessment items.

According to an embodiment, in order for objective index calculation, assessment values for the assessment items of the political system stability index x_{g} may be quantified by referring to the Worldwide Governance Indicator (WGI) that is annually published by the World Bank.

Next, in stage S32, the business execution stability assessment section 30 calculates the general business execution stability index x_{b} for smoothness of investment and business and stability of executing business in the host country.

In detail, the general business execution stability index x_{b} is calculated, based on assessment values respectively quantified for assessment items including starting a business, dealing with construction permits, getting electricity, registering property, getting credit, protecting investors, paying taxes, trade across borders, enforcing contracts, and resolving insolvency.

According to an embodiment, the general business execution stability index x_{b} may be calculated, based on any one selected from summation, weighted summation, arithmetic averaging and weighted averaging of the assessment values respectively quantified for the respective assessment items.

In order for objective index calculation, assessment values for the assessment items of the general business execution stability index x_{b} may be quantified by referring to the Doing Business Indicator (DBI) that is annually published commonly by the World Bank and the International Finance Corporation (IFC) with respect to business performance easiness of 185 countries over the world, and Distance to Frontier (DF) values provided therewith, for the assessment items.

Then, in stage S33, the business execution stability assessment section 30 calculates the upstream expected reward index xᵤ for an expected reward in the upstream field for the investment of the overseas gas field development project.

In detail, the upstream expected reward index xᵤ is calculated, based on assessment values respectively quantified for assessment items including natural gas reserves, average annual production of natural gas, maximum production of natural gas, growth rate of production of natural gas, ratio of upstream properties not owned by the government, and ratio of upstream enterprises not owned by the government.

According to an embodiment, the upstream expected reward index xᵤ may be calculated, based on any one selected from summation, weighted summation, arithmetic averaging and weighted averaging of the assessment values respectively quantified for the respective assessment items.

For example, the weight of 0.1875 may be applied to each of the first four assessment items, that is, natural gas reserves, average annual production of natural gas, maximum production of natural gas and growth rate of production of natural gas, and the weight of 0.125 may be applied to each of the remaining two assessment items, that is, ratio of upstream properties not owned by the government and ratio of upstream enterprises not owned by the government.

In succession, in stage S34, the business execution stability assessment section 30 calculates the downstream expected reward index x_{d} for an expected reward in the downstream field for the investment of the overseas gas field development project.

In detail, the downstream expected reward index x_{d} is calculated based on assessment values respectively quantified for assessment items including annual local demand for natural gas, growth rate of local demand for natural gas, local supply-demand ratio of natural gas, ratio of downstream properties not owned by the government, and ratio of downstream enterprises not owned by the government.

According to an embodiment, the downstream expected reward index x_{d} may be calculated, based on any one selected from summation, weighted summation, arithmetic averaging and weighted averaging of the assessment values respectively quantified for the respective assessment items.

For example, the weight of 0.25 may be applied to each of the first three assessment items, that is, annual local demand for natural gas, growth rate of local demand for natural gas and local supply-demand ratio of natural gas, and the weight of 0.125 may be applied to each of the remaining two assessment items, that is, ratio of downstream properties not owned by the government and ratio of downstream enterprises not owned by the government.

Thereafter, in stage S35, the business execution stability assessment section 30 calculates the business promotion condition index xₚ for the administrative conditions and competitive conditions of the gas industry of the host country.

In detail, the business promotion condition index xₚ is calculated, based on assessment values respectively quantified for assessment items including energy-related policies of the government of the host country, a natural gas management structure of the government of the host country, a current situation of similar projects in progress on the site, and a current situation of similar projects under planning on the site.

According to an embodiment, the business promotion condition index xₚ may be calculated, based on any one selected from summation, weighted summation, arithmetic averaging and weighted averaging of the assessment values respectively quantified for the respective assessment items.

For example, the weight of 0.3 may be applied to each of the assessment items such as energy-related policies of the government of the host country and a natural gas management structure of the government of the host country, and the weight of 0.2 may be applied to each of the remaining two assessment items, that is, a current situation of similar projects in progress on the site and a current situation of similar projects under planning on the site.

Finally, in stage S36, the overall business environment assessment section 40 calculates the business environment index xₜ, based on the political system stability index x_{g}, the business execution stability index x_{b}, the upstream expected reward index xᵤ, the downstream expected reward index x_{d} and the business promotion condition index xₚ.

According to an embodiment, the business environment index xₜ may be calculated, based on any one selected from summation, weighted summation, arithmetic averaging and weighted averaging of the respective indexes x_{g}, x_{b}, Xᵤ, X_{d} and xₚ.

According to the system and the method for analyzing business environment of an overseas gas field development project in accordance with the embodiment of the present invention, it is possible to analyze business environment of an overseas gas field development project in terms of investment and reward as well as in terms of construction or EPC perspectives.

According to the system and the method for analyzing business environment of an overseas gas field development project in accordance with the embodiment of the present invention, it is possible to analyze business environment of an overseas gas field development project in consideration of not only the macroscopic situation of an host country but also all processes including drilling of a gas field, construction of a plant, mining, refinement, treatment, transportation, storage, and sale.

The exemplary embodiments of the present invention and the drawings included in the present specification are to clearly describe some of technical ideas included in the present invention, and it is apparent that the modifications and the detailed exemplary embodiments easily derived for the concerned personnel without departing from the technical spirit included in the specification and drawings of the present invention fall under the scope of protection in the present invention.

The apparatus in accordance with the embodiment of the present invention may be realized by computer-readable codes in a computer-readable recording medium. The computer-readable recording medium includes all kinds of recording devices in which data that may be read by a computer system are stored. Examples of the recording medium includes a ROM, a RAM, an optical disk, a magnetic tape, a floppy disk, a hard disk, a nonvolatile memory, and so forth. In addition, the computer-readable recording medium may be distributed in computer systems which are connected through a network, such that codes that may be read in a distributed scheme by computers may be stored and executed in the computer readable recording medium.

What is claimed is:

1. A system for analyzing country's business environment of an overseas gas field development project, comprising:
a political system stability assessment section configured to calculate a political system stability index for macroscopic stability of political and social systems of a host country that owns an overseas gas field as a development target;
a business execution stability assessment section configured to respectively calculate a general business execution stability index for smoothness of investment and business and stability of executing business in the host country, an upstream expected reward index for an expected reward in an upstream field for investment of the overseas gas field development project, a downstream expected reward index for an expected reward in a downstream field for investment of the overseas gas field development project, and a business promotion condition index for administrative conditions and competitive conditions of the gas industry of an host country; and
an overall country's business environment assessment section configured to calculate a business environment index, based on the political system stability index, the business execution stability index, the upstream expected reward index, the downstream expected reward index and the business promotion condition index.

2. The system according to claim 1, wherein the political system stability index is calculated, based on assessment values respectively quantified for assessment items including voice and accountability, political stability and absence of violence, government effectiveness, regulatory quality, rule of law, and control of corruption.

3. The system according to claim 2, wherein the political system stability index is calculated, based on any one selected from summation, weighted summation, arithmetic averaging and weighted averaging of the assessment values respectively quantified for the respective assessment items.

4. The system according to claim 2, wherein the assessment values for the assessment items of the political system stability index are quantified by referring to the Worldwide Governance Indicator (WGI) that is annually published by the World Bank.

5. The system according to claim 1, wherein the general business execution stability index is calculated, based on assessment values respectively quantified for assessment items including starting a business, dealing with construction permits, getting electricity, registering property, getting credit, protecting investors, paying taxes, trade across borders, enforcing contracts, and resolving insolvency.

6. The system according to claim 5, wherein the general business execution stability index is calculated, based on any one selected from summation, weighted summation, arithmetic averaging and weighted averaging of the assessment values respectively quantified for the respective assessment items.

7. The system according to claim 5, wherein the assessment values for the assessment items of the general business execution stability index are quantified by referring to the Doing Business Indicator (DBI) that is annually published commonly by the World Bank and the International Finance Corporation (IFC), and Distance to Frontier (DF) values provided therewith, for the assessment items.

8. The system according to claim 1, wherein the upstream expected reward index is calculated, based on assessment values respectively quantified for assessment items including natural gas reserves, average annual production of natural gas, maximum production of natural gas, growth rate of production of natural gas, ratio of upstream properties not owned by a government, and ratio of upstream enterprises not owned by the government.

9. The system according to claim 8, wherein the upstream expected reward index is calculated, based on any one selected from summation, weighted summation, arithmetic averaging and weighted averaging of the assessment values respectively quantified for the respective assessment items.

10. The system according to claim 1, wherein the downstream expected reward index is calculated, based on assessment values respectively quantified for assessment items including annual local demand for natural gas, growth rate of local demand for natural gas, local supply-demand ratio of natural gas, ratio of downstream properties not owned by the government, and ratio of downstream enterprises not owned by the government.

11. The system according to claim 10, wherein the downstream expected reward index is calculated, based on any one selected from summation, weighted summation, arithmetic averaging and weighted averaging of the assessment values respectively quantified for the respective assessment items.

12. The system according to claim 1, wherein the business promotion condition index is calculated, based on assessment values respectively quantified for assessment items including energy-related policies of the government of the host country, a natural gas management structure of the government of the host country, a current situation of similar projects in progress on the site, and a current situation of similar projects under planning on the site.

13. The system according to claim 12, wherein the business promotion condition index is calculated, based on any one selected from summation, weighted summation, arithmetic averaging and weighted averaging of the assessment values respectively quantified for the respective assessment items.

14. The system according to claim 1, wherein the business environment index is calculated, based on any one selected from summation, weighted summation, arithmetic averaging and weighted averaging of the political system stability index, the business execution stability index, the upstream expected reward index, the downstream expected reward index and the business promotion condition index.

15. A recording medium configured to be read by a computer recorded with a computer program which is realized to operate the computer as the system for analyzing business environment of an overseas gas field development project according to any one of claims 1 to 14.

16. A method for analyzing business environment of an overseas gas field development project, using a system for analyzing business environment of an overseas gas field development project, which includes a political system stability assessment section, a business execution stability assessment section and an overall business environment assessment section, the method comprising:
calculating, by the political system stability assessment section, a political system stability index for macroscopic stability of political and social systems of a country that owns an overseas gas field as a development target, that is, a host country;
calculating, by the business execution stability assessment section, a general business execution stability index for smoothness of investment and business and stability of executing business in the host country;
calculating, by the business execution stability assessment section, an upstream expected reward index for an expected reward in an upstream field for investment of the overseas gas field development project;
calculating, by the business execution stability assessment section, a downstream expected reward index for an expected reward in a downstream field for investment of the overseas gas field development project;
calculating, by the business execution stability assessment section, a business promotion condition index for administrative conditions and competitive conditions of the gas industry of an host country; and
calculating, by the overall business environment assessment section, a business environment index, based on the political system stability index, the business execution stability index, the upstream expected reward index, the downstream expected reward index and the business promotion condition index.

17. The method according to claim 16, wherein the political system stability index is calculated, based on assessment values respectively quantified for assessment items including voice and accountability, political stability and absence of violence, government effectiveness, regulatory quality, rule of law, and control of corruption.

18. The method according to claim 17, wherein the assessment values for the assessment items of the political system stability index are quantified by referring to the Worldwide Governance Indicator (WGI) that is annually published by the World Bank.

19. The method according to claim 16, wherein the general business execution stability index is calculated, based on assessment values respectively quantified for assessment items including starting a business, dealing with construction permits, getting electricity, registering property, getting credit, protecting investors, paying taxes, trade across borders, enforcing contracts, and resolving insolvency.

20. The method according to claim 19, wherein the assessment values for the assessment items of the general business execution stability index are quantified by referring to the Doing Business Indicator (DBI) that is annually published commonly by the World Bank and the International Finance Corporation (IFC), and Distance to Frontier (DF) values provided therewith, for the assessment items.

21. The method according to claim 16, wherein the upstream expected reward index is calculated, based on assessment values respectively quantified for assessment items including natural gas reserves, average annual production of natural gas, maximum production of natural gas, growth rate of production of natural gas, ratio of upstream properties not owned by a government, and ratio of upstream enterprises not owned by the government.

22. The method according to claim 16, wherein the downstream expected reward index is calculated, based on assessment values respectively quantified for assessment items including annual local demand for natural gas, growth rate of local demand for natural gas, local supply-demand ratio of natural gas, ratio of downstream properties not owned by the government, and ratio of downstream enterprises not owned by the government.

23. The method according to claim 16, wherein the business promotion condition index is calculated, based on assessment values respectively quantified for assessment items including energy-related policies of the government of the host country, a natural gas management structure of the government of the host country, a current situation of similar projects in progress on the site, and a current situation of similar projects under planning on the site.

24. The method according to claim 16, wherein the business environment index is calculated, based on any one selected from summation, weighted summation, arithmetic averaging and weighted averaging of the political system stability index, the business execution stability index, the upstream expected reward index, the downstream expected reward index and the business promotion condition index.

25. A recording medium configured to be read by a computer recorded with a computer program which realizes the method for analyzing business environment of an overseas gas field development project according to any one of claims 16 to 24, in the computer.
